(19) United States
(12) Patent Application Publication
(10) Pub. No.: US 2010/0302791 A1
(43) Pub. Date: Dec. 2, 2010

(54) Single-Ended Fluorescent Lamp and a Luminaire Matched With the Single-Ended Fluorescent Lamp For Use

(76) Inventor: Frank TSAO, Dongguan (CN)

Correspondence Address: Jackson Intellectual Property Group PLLC, 106 Starvale Lane, Shipman, VA, 22971, US

(21) Appl. No.: 12/787,497

(22) Filed: May 26, 2010

(30) Foreign Application Priority Data
May 27, 2009 (CN) 200920057352.5

(51) Int. Cl. F21V 15/01; H01J 5/50

(52) U.S. Cl. 362/375; 313/51

(57) ABSTRACT

The present invention discloses a single-ended fluorescent tube which comprises a glass tube lamp tube and a lamp cap, wherein the lamp cap comprises a glass tube lamp tube fixed seat and an electric plug connector, the glass tube lamp tube is arranged on the glass tube lamp tube fixed seat, and the electric plug connector is arranged on the glass tube lamp tube fixed seat. The single-ended fluorescent tube is characterized in that the power supply plug of the lamp cap is vertical to the axis of the glass tube lamp tube; the present invention also discloses a luminaire matched with the single-ended fluorescent tube for use, which comprises a lamp frame cover and a lamp holder, wherein a socket is arranged in the lamp holder.

### FIELD OF THE INVENTION

The present invention relates to a single-ended fluorescent lamp and a luminaire matched with the single-ended fluorescent lamp for use.

### BACKGROUND OF THE INVENTION

At present, standard manufacture methods of multiple tube type single-ended fluorescent lamp are the same (such as the American standard ANSI C78.901, European standard IEC-60901, GB GB17262 and the like) as shown in FIG. 1, wherein the structures of lamp caps of a single-ended fluorescent lamp 1 (double tube type, four-tube type, multiple tube type single-ended fluorescent lamps) require that an electric plug connector 13 and a glass tube lamp 12 which are arranged on a glass tube lamp fixed seat 11 are on the same central axis; and due to the restrictions of standard practice of the structure of the lamp cap, the lamp is caused to be required to maintain a coaxial surface with a lamp holder 2 on a luminaire when installed, meanwhile, the lamp is required to be inserted or pulled out on a same axes with the lamp holder 2 and a lamp 12 when assembled and taken off, therefore the lamp is certain to put apart two segments of invalid space as shown in FIG. 2, one segment is installation space 21 for installing the lamp holder, the other segment is buffer space 22 which is certain to be put apart when the lamp is inserted and pulled out, the lamp has a segment of larger invalid space integrally, the volume can not be compacted to an idealized level, and the lamp can be crashed because the force is not easy to control when the lamp is inserted and pulled out during use.

### SUMMARY OF THE INVENTION

The purpose of the present invention has the purpose to provide a single-ended fluorescent lamp and a luminaire structure matched with the single-ended fluorescent lamp for use. The lamp structure enables the lamp to have small integral volume so as to better save lamp space and install conveniently, and easily controls the force to protect and prevent the lamp from crashing when the lamp is inserted and pulled out during use.

The purpose of the present invention is achieved by the following technical schemes. A single-ended fluorescent lamp comprises a glass tube lamp and a lamp cap, the lamp cap comprises a glass tube lamp fixed seat and an electric plug connector, the glass tube lamp is arranged on the glass tube lamp fixed seat, and the electric plug connector is arranged on the glass tube lamp fixed seat. The single-ended fluorescent tube is characterized in that the power plug of the lamp cap is vertical to the axis of the glass tube lamp, wherein the glass tube lamp is dual tube type, four-tube type or over four-tube type.

A luminaire matched with the single-ended fluorescent lamp for use comprises a lamp frame cover and a lamp cap, wherein the lamp frame cover comprises a lamp cover and a lamp frame fixed on the lamp cover, and the lamp cover and the lamp frame are sealed to form a hollow cavity for accommodating the single-ended fluorescent tube. The luminaire is characterized in that the socket is arranged in the hollow cavity formed by sealing the lamp cover and the lamp frame, and the axis of socket holes on the socket is vertical to the mounting surface of the lamp frame and the lamp cover.

Compared with the prior art, the present invention has the following advantages:

In the present invention, because the electric plug connector is vertical to the axis of the glass tube lamp tube, total length of the single-ended fluorescent lamp is shortened so that the single-ended fluorescent lamp can be directly inserted in the lamp cover of the lamp vertically. Compared with traditional lamps, the lamps do not need reserved and assembled buffer space, improves the space utilization of the lamp and significantly reduces the integral volume of the lamp. Thus the total length of the single-ended fluorescent lamp to achieve better compact effect; because the electric plug connector is vertical to the axis of the lamp, the single-ended fluorescent lamp facilitates installation by the user, has convenience and safety, has no danger of cracking the lamp easily during the assembly process of standard lamps, can save manufacture material of lamps, can be widely used for industrial and civil lighting places like construction sites, factories, docks, markets, roads and the like.

### BRIEF DESCRIPTION OF THE DRAWINGS

FIG. 1 is a structural schematic diagram of a single-ended fluorescent lamp in the prior art;

FIG. 2 is a structural schematic diagram of a luminaire of the single-ended fluorescent lamp installed in FIG. 1 in the prior art;

FIG. 3 is a structural schematic diagram of a single-ended fluorescent lamp of the present invention;

FIG. 4 is a structural schematic diagram of the lamp of the present invention; and

FIG. 5 is a structural schematic diagram of an installed single-ended fluorescent lamp of the present invention.

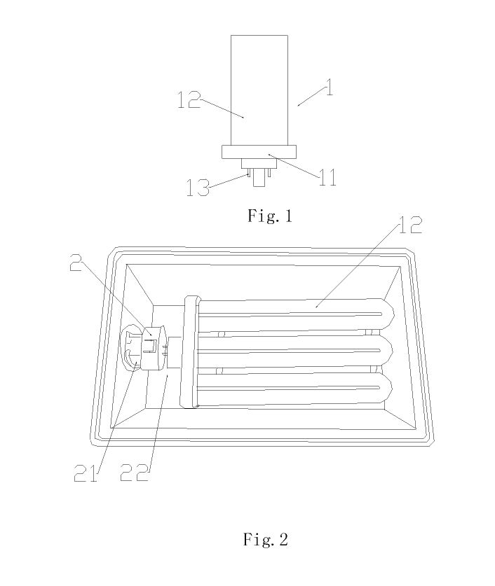

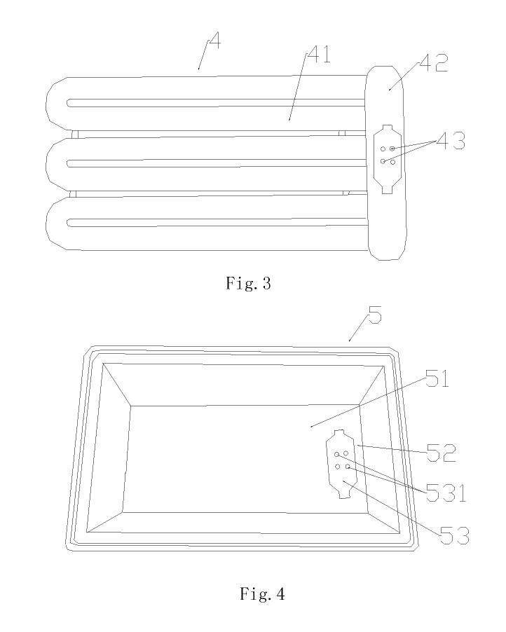

### DESCRIPTIONG OF THE PREFERRED EMBODIMENT

By combining with the attached drawings, the following is further description of the single-ended fluorescent lamp and the lamp structure matched with the single-ended fluorescent lamp for use in detail.

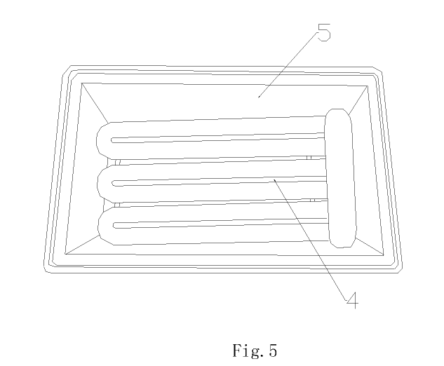

As shown in FIGS. 3-5, the single-ended fluorescent lamp 4 comprises a glass tube lamp 41 and a lamp cap which comprises a glass tube lamp fixed seat 42 and an electric plug connector 43, the glass tube lamp 41 is arranged on the glass tube lamp fixed seat 42, the electric plug connector 43 is arranged on the glass tube lamp fixed seat 42, wherein the glass tube lamp 41 is dual tube type or four-tube type or over four-tube type, and the electric plug connector 43 is vertical to the axis of the glass tube lamp 41. A luminaire 5 matched with the single-ended fluorescent lamp 4 for use comprises a lamp frame cover 51 and a lamp holder 52, the lamp frame cover 51 comprises a lamp cover and a lamp frame fixed on the lamp cover, and the lamp cover and the lamp frame are sealed to form a hollow cavity for accommodating the single-ended fluorescent tube; a socket 53 for inserting the electric plug connector 43 is arranged in the lamp holder 52 and in the hollow cavity, the axis of socket holes 531 on the socket 53 is vertical to the mounting surface of the lamp frame and the lamp cover, that is the axis of the socket holes 531 is vertical to the top surface of the hollow cavity, therefore when the installation of the single-ended fluorescent tube 4 changes traditional installing mode, that is when assembled and taken off, the single-ended fluorescent tube 4 is inserted or pulled out on the same axis with the lamp holder and the lamp tube. But now when the single-ended fluorescent tube is assembled and taken off, the lamp holder and the lamp tube are vertically inserted or pulled out, thereby reserved and assembled buffer space is not needed, and space utilization rate of the lamp is improved, and integral volume of the lamp is significantly reduced.

What is claimed is:

1. A single-ended fluorescent lamp comprising a glass tube lamp and a lamp cap, the lamp cap comprising a glass tube lamp fixed seat and an electric plug connector, the glass tube lamp arranged on the glass tube lamp fixed seat, the electric plug connector arranged on the glass tube lamp fixed seat, characterized in that the power supply plug of the lamp cap is vertical to the axis of the glass tube lamp.

2. The single-ended fluorescent lamp of claim 1, wherein the glass tube lamp is dual tube type.

3. The single-ended fluorescent lamp of claim 1, wherein the glass tube lamp is four-tube type or over four-tube type.

4. A luminaire matched with the single-ended fluorescent lamp of claim 1 comprising a lamp frame cover and a lamp holder, a socket for inserting an electric plug connector of the lamp cap arranged in the lamp holder, the lamp frame cover comprising a lamp cover and a lamp frame fixed on the lamp cover, and the lamp cover and the lamp frame sealed to form a hollow cavity for accommodating the single-ended fluorescent lamp, characterized in that the socket is arranged in the hollow cavity formed by sealing the lamp cover and the lamp frame, and the axis of socket holes on the socket is vertical to the mounting surface of the lamp frame and the lamp cover.
